(19) United States
(12) Patent Application Publication
(10) Pub. No.: US 2012/0081632 A1
(43) Pub. Date: Apr. 5, 2012

(54) LIGHTING DEVICE, DISPLAY DEVICE, TELEVISION RECEIVER

(75) Inventor: Masashi Yokota, Osaka-shi (JP)

(73) Assignee: Sharp Kabushiki Kaisha, Osaka-shi, Osaka (JP)

(21) Appl. No.: 13/377,235

(22) PCT Filed: Apr. 21, 2010
(86) PCT No.: PCT/JP2010/057045

§ 371 Date: Dec. 9, 2011

(30) Foreign Application Priority Data
Jun. 17, 2009 (JP) 2009-144285

(51) Int. Cl. G02F 1/1335; G09F 13/04; F21V 21/00; F21V 15/01; F21V 7/00

(52) U.S. Cl. 349/61; 362/362; 362/296.01; 362/217.1; 362/97.1

(57) ABSTRACT

It is an object of the present invention to provide a lighting device that can attain a reduction in thickness. A lighting device according to the present invention includes a hot-cathode tube 50, a circuit board 80, and a second cabinet Cb. The circuit board 80 is configured to supply electric power to the hot-cathode tube 50. The second cabinet Cb has a rectangular shape in plan view and houses the hot-cathode tube 50 and the circuit board 80. The hot-cathode tube 50 is arranged in a center area of the second cabinet Cb with respect to a longer-side direction or a shorter-side direction of the second cabinet Cb to form a board housing section 30b. The board housing section 30b houses the circuit board 80. The board housing section 30b is provided in at least one of outer areas each located on either side of the center area with respect to the longer-side direction or the shorter-side direction in the second cabinet Cb.

### TECHNICAL FIELD

The present invention relates to an lighting device, a display device, and a television receiver.

### BACKGROUND ART

In recent years, display elements of image display devices such as a television receiver are being shifted from the conventional cathode-ray tube to thin display devices to which thin display elements such as a liquid crystal panel and a plasma display panel are applied. This makes it possible to reduce the thickness of an image display device. A liquid crystal panel used for a liquid crystal display device does not spontaneously emit light. Therefore, a backlight is separately required as an lighting device. A backlight described in Patent Literature 1 includes a light source, a housing to which the light source is attached, and an electric circuit for turning on the light source.

### PRIOR ART DOCUMENT

### Patent Document

Patent Document 1: Japanese Unexamined Patent Application Publication No. 10-106342

### PROBLEM TO BE SOLVED BY THE INVENTION

A further reduction in thickness is demanded in the image display device. However, in order to attain the reduction in thickness, it is effective to reduce the thicknesses of components of the image display device, in particular, the backlight that is a component having relatively large thickness. In the backlight described in Patent Literature 1, the light source and the electric circuit are arranged side by side in the thickness direction of the housing. In such a component arrangement, the thickness of the housing is larger and it is difficult to reduce the thickness of the backlight.

### DISCLOSURE OF THE PRESENT INVENTION

The present invention has been completed on the basis of the circumstances explained above and it is an object of the present invention to provide a lighting device that can attain a reduction in thickness. It is also an object of the present invention to provide a display device and a television receiver including such a lighting device.

### MEANS FOR SOLVING THE PROBLEM

In order to solve the aforementioned problems, a lighting device according to the present invention includes a light source, a power supply board, and a housing member. The power supply board is configured to supply electric power to the light source. The housing member has a rectangular shape in plan view, and houses the light source and the power supply board. The light source is arranged in a center area of the housing member with respect to a longer-side direction or a shorter-side direction of the housing member to form a board housing section in at least one of outer areas each located on either side of the center area with respect to the longer-side direction or the shorter-side direction of the housing member. The board housing section houses the power supply board.

With this configuration, since the power supply board is arranged in the board housing section, it is possible to arrange the light source and the power supply board side by side respectively in different positions in the longer-side direction or the shorter-side direction of the housing member. As a result, it is possible to reduce the thickness of the housing member (the length in a direction orthogonal to the longer-side direction and the shorter-side direction) as much as possible and reduce the thickness of the lighting device. In order to form the board housing section, for example, a configuration is also conceivable in which the light source is arranged at one end area of the housing ember with respect to the longer-side direction or the shorter-side direction and the other end space is formed as the board housing section. However, in this configuration, since a distance from the light source to the other end area increases, the luminance on the other end area is low compared with the luminance on one end area and luminance unevenness tends to occur. In this regard, in the present invention, since the light source is arranged in the center in the longer-side direction or the shorter-side direction in the housing member, it is possible to suppress luminance unevenness compared with the configuration in which the light source is arranged on one end area. The shorter-side direction of the housing member indicates a short-side direction of the housing member.

### BRIEF DESCRIPTION OF THE DRAWINGS

FIG. 1 is a disassembled perspective view showing a schematic configuration of a television receiver according to a first embodiment of the present invention.

FIG. 2 is a sectional schematic view showing a state in which a liquid crystal display device is cut along a longer-side direction.

FIG. 3 is a sectional schematic view showing a state in which the liquid crystal display device is cut along a shorter-side direction.

FIG. 4 is a disassembled view showing disassembled components in the state in which the liquid crystal display device is cut along the shorter-side direction.

FIG. 5 is a schematic view showing a form of attaching a liquid crystal panel to a first cabinet in the first embodiment.

FIG. 6 is a schematic view showing a form of placing an optical sheet on a second cabinet in the first embodiment.

FIG. 7 is a schematic view showing a form of assembling the first cabinet and the second cabinet in the first embodiment.

FIG. 8 is a plan view for explaining distribution of optical reflectance on a surface opposed to hot-cathode tubes of a diffuser.

FIG. 9 is a sectional schematic view showing the configuration of a liquid crystal display device according to a second embodiment.

FIG. 10 is a sectional schematic view showing the configuration of a liquid crystal display device according to a third embodiment.

FIG. 11 is a plan view showing the configuration of a second cabinet according to the third embodiment.

FIG. 12 is an A-A line sectional view in FIG. 11.

### MODE FOR CARRYING OUT THE INVENTION

### First Embodiment

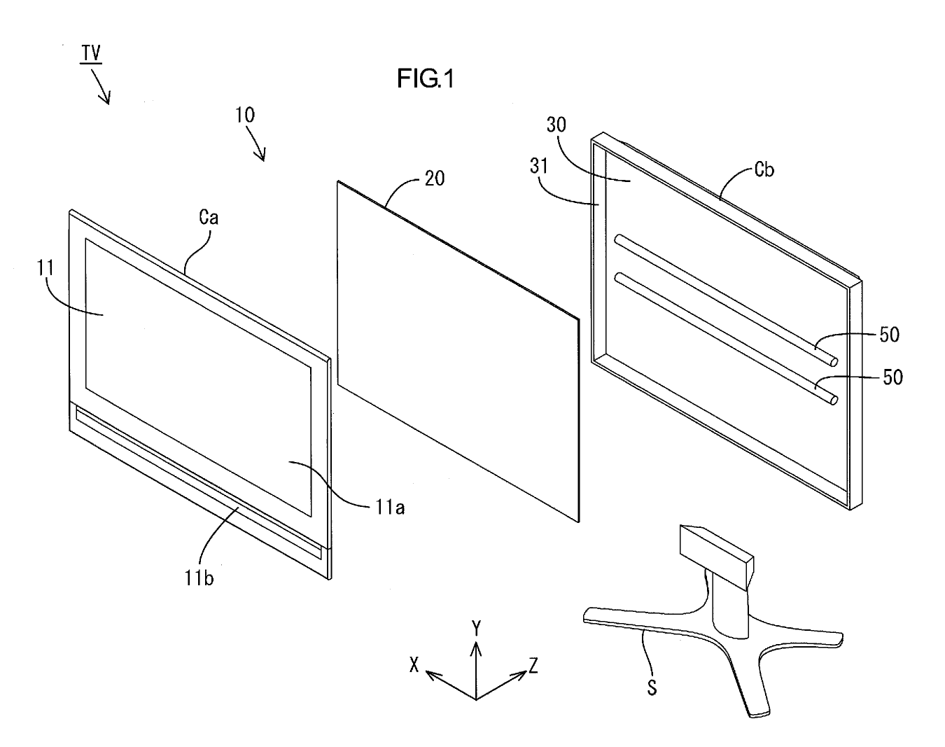

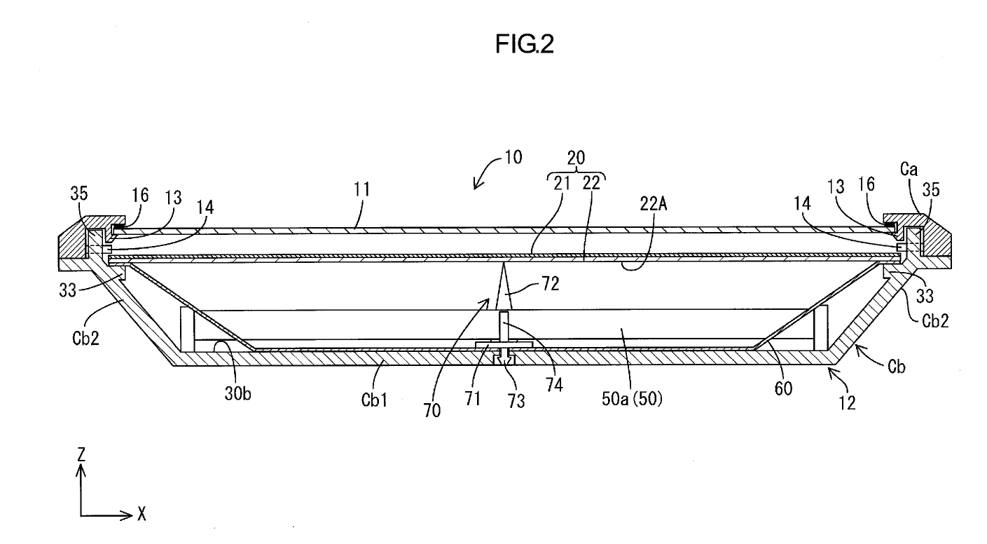

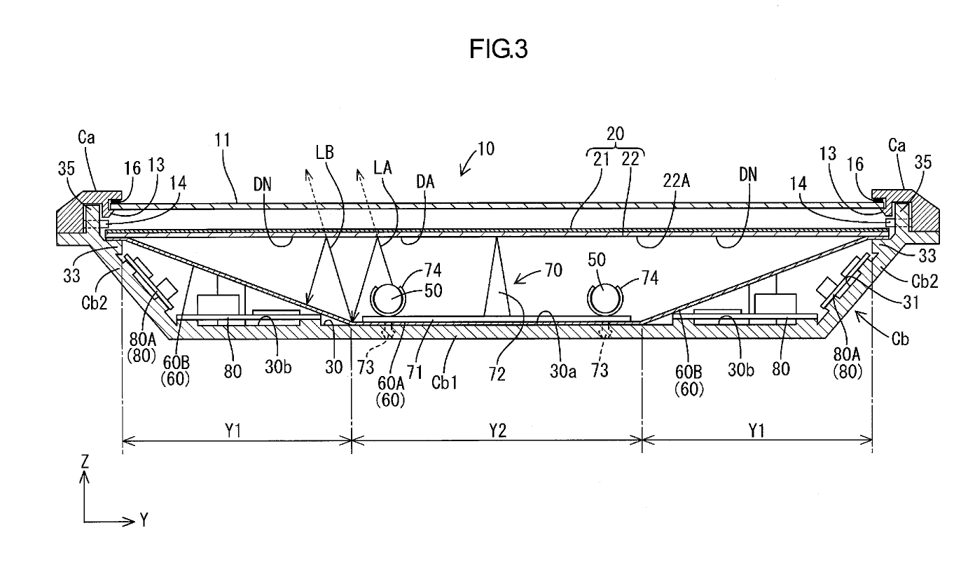

A first embodiment of the present invention is explained with reference to FIGS. 1 to 8. In this embodiment, an X axis, a Y axis, and a Z axis are shown in a part of the drawings. Axis directions are drawn to be directions shown in the drawings. An upper side shown in FIGS. 2 and 3 is set as a front side and a lower side in the figures is set as a rear side. A television receiver TV according to this embodiment shown in FIG. 1 includes a liquid crystal display device 10, a stand S for placing the liquid crystal display device 10, a not-shown power supply, a not-shown tuner and the like.

The liquid crystal display device (a display device) 10 is formed in a square shape long in sideways as a whole and supported by the stand S such that a display surface extends along the vertical direction (the Y axis direction). The liquid crystal display device 10 includes a backlight device 12 (a lighting device), which is an external light source, a liquid crystal panel 11 (a display panel) that performs display using light from the backlight device 12, and a first cabinet Ca (a panel attachment member) to which the liquid crystal panel 11 can be attached.

The backlight device 12 includes hot-cathode tubes (light sources) 50, circuit boards 80, and a second cabinet Cb (a housing member) in which the hot-cathode tubes 50 and the circuit boards 80 can be housed. The external shapes of the first cabinet Ca and the second cabinet Cb are formed in substantially the same sizes in plan view. The first cabinet Ca and the second cabinet Cb are engaged to configure an exterior component (a cabinet) of the liquid crystal display device 10.

The first cabinet Ca is formed of a frame-like resin member. The liquid crystal panel (the display panel) 11 is attached to the first cabinet Ca to be housed in the frame. A display surface 11a of the liquid crystal panel 11 is arranged in the frame. A speaker 11b and the like are provided on the surface side of the first cabinet Ca. On the other hand, the second cabinet Cb is formed of a box-like resin member having an opening on the front side and includes a bottom surface 30 that forms a box bottom and a wall section 31 vertically provided from the bottom surface 30 as shown in FIG. 2. The hot-cathode tubes 50 are attached to the bottom surface 30.

Specifically, the second cabinet Cb is attached on the opposite side of the display surface 11a of the liquid crystal panel 11 with respect to the first cabinet Ca and light is supplied from the hot-cathode tubes 50 of the second cabinet Cb to the liquid crystal panel 11. An optical sheet 20 (an optical member) is arranged between the first cabinet Ca and the second cabinet Cb, specifically, between the liquid crystal panel 11 and the hot-cathode tubes 50 and diffuses the light from the hot-cathode tubes 50 in a planar shape.

The liquid crystal panel 11 has a configuration in which a pair of glass boards are bonded with a predetermined gap apart from each other and liquid crystal is filled between both the glass boards. On one glass board, a switching element (e.g., TFT) connected to a source wire and a gate wire orthogonal to each other, a pixel electrode connected to the switching element, an oriented film, and the like are provided. On the other glass board, a color filter on which colored sections of R (red), G (green), B (blue), and the like are arranged in a predetermined array, a counter electrode, an oriented film, and the like are provided. Sheet polarizers are arranged on the outer sides of both the boards.

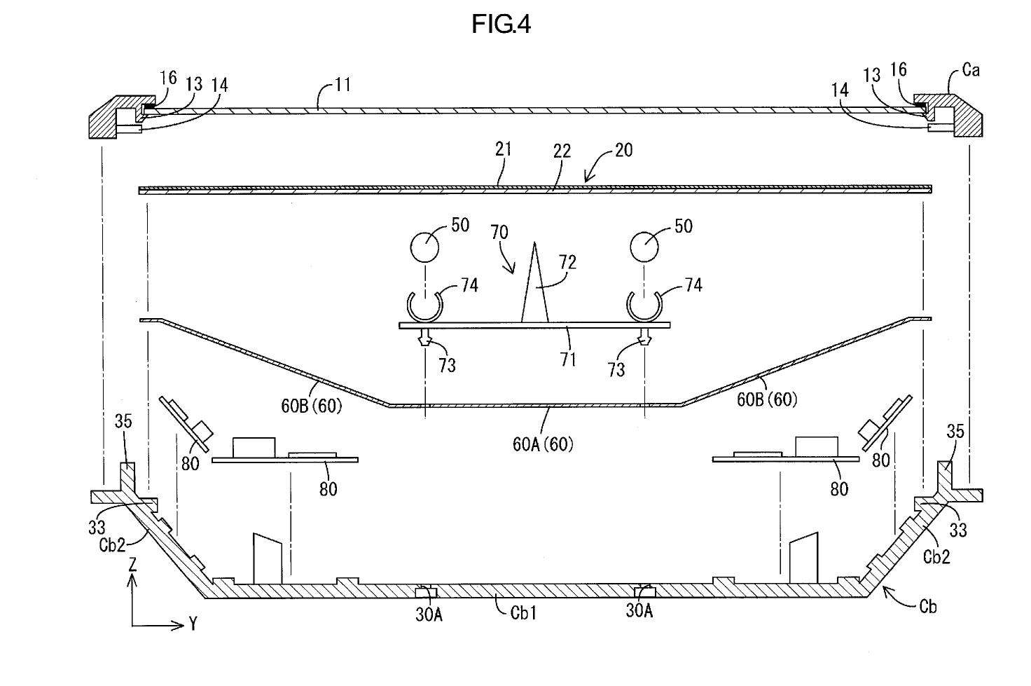

As shown in FIGS. 2 and 4, the optical sheet 20 is configured by placing, one on top of the other, a diffuser 22 having large thickness arranged on the second cabinet Cb side and sheets 21 (a diffusing lens, a reflective polarizing sheet, etc.) having small thickness arranged on the first cabinet Ca side. The diffuser 22 is configured by dispersing light scattering particles in a tabular member made of a synthetic resin and has a function of diffusing linear light emitting from the hot-cathode tubes 50, which are linear light sources.

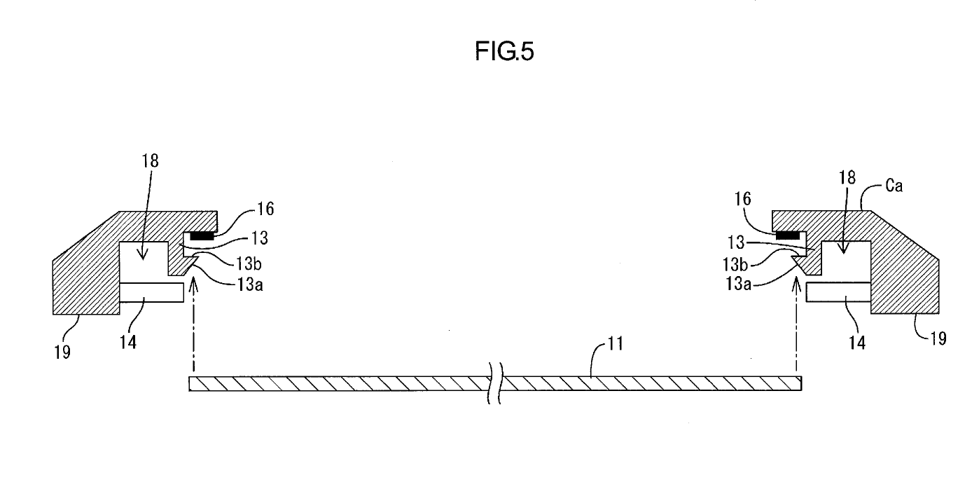

Next, the configuration of the first cabinet Ca (the panel attachment member) is explained. As shown in FIG. 2, the first cabinet Ca includes a claw section 13 for locking the liquid crystal panel 11. As shown in FIG. 5, the claw section 13 includes a locking surface 13b. The claw section 13 holds the liquid crystal panel 11 between the locking surface 13b and an elastic member 16 (such as PORON®) 16 arranged to be opposed to the locking surface 13b. The claw section 13 itself is elastically deformable. The claw section 13 is configured to be elastically deformed in a direction in which the claw section 13 widens (to the outer side) when the liquid crystal panel 11 is attached to the first cabinet Ca and elastically returns in a direction in which the liquid crystal panel 11 is tightened (to the inner side) after the liquid crystal panel 11 is attached.

A slope 13a is provided in the claw section 13 of the first cabinet Ca to make it possible to, while guiding the liquid crystal panel 11 in a pressing direction (an arrow direction in FIG. 5), elastically deform the claw section 13 according to the pressing when the liquid crystal panel 11 is housed in the locking surface 13b of the claw section 13. On the rear side of the claw section 13, i.e., on the opposite side of a side where the liquid crystal panel 11 is locked, a projection housing section 18 for housing a projection 35 of the second cabinet Cb explained later is formed. A piece for holding 14 for holding the optical sheet 20 is formed in the first cabinet Ca.

The configuration of the second cabinet Cb (the housing member) is explained. The second cabinet Cb is formed in a rectangular shape. As shown in FIG. 2, the second cabinet Cb includes a bottom plate Cb1 that forms the bottom surface 30 and a wall plate Cb2 that forms the wall section 31. The wall section 31 tilts to be oriented to the inner side at a predetermined angle with respect to the bottom surface 30.

A reflection sheet 60 for reflecting light emitted from the hot-cathode tubes 50 to the inner surface of the second cabinet Cb is laid on the bottom plate Cb1. The reflection sheet 60 is made of a synthetic resin. The surface of the reflection sheet 60 is colored in white excellent in light reflection properties. The reflection sheet 60 is laid to cover substantially the entire region of the inner surface of the second cabinet Cb along the inner surface. Specifically, the reflection sheet 60 includes a bottom section 60A laid along the bottom surface 30 and a tilting section 60B extending from the bottom section 60A. The tilting section 60B tilts to the front side with respect to the bottom surface 30 and is configured to form a space (a board housing section 30b explained later) between the tilting section 60B and the bottom surface 30. Since the reflection sheet 60 includes the tilting section 60B, the reflection sheet 60 can orient reflected light to the inner side (the center side of the display device).

A sheets holding section 33 for placing the reflection sheet 60 and the optical sheet 20 is formed at the top portion of the wall section 31. The projection 35 projecting to the first cabinet Ca side is formed on a placing surface of the sheets holding section 33. The sheets holding section 33 holds the optical sheet 20 between the sheets holding section 33 and the piece for holding 14 of the first cabinet Ca. The projection 35 regulates the movement of the optical sheet 20 in a surface direction on the inner side of the projection 35. As explained above, the projection 35 is housed in the projection housing section 18 arranged on the rear side (the outer side) of the claw section 13 of the first cabinet Ca. The projection 35 urges the claw section 13 to the liquid crystal panel 11 side (the inner side) from the rear side (the outer side).

As shown in FIG. 3, in the bottom plate Cb1, two hot-cathode tubes 50 are attached on the bottom surface 30 thereof via a lamp clip 70. As shown in FIGS. 2 and 3, the hot-cathode tubes 50 are formed as linear light sources assuming a slender tube shape. The hot-cathode tubes 50 are arranged in a state in which a longer-side direction (an axial direction) thereof is matched with a longer-side direction (the X axis direction) of the second cabinet Cb. In the Y axis direction, the hot-cathode tubes 50 are arranged in a state in which the hot-cathode tubes 50 extend side by side in parallel to each other. The hot-cathode tube 50 includes a hollow glass tube 50a assuming a tube shape and a pair of electrodes (not shown) arranged at both ends of the glass tube 50a. In the glass tube 50a, mercury, rare gas, or the like is enclosed. A fluorescence material is applied to the inner wall surface of the glass tube 50a.

The lamp clip 70 includes a plate section 71 applied to the bottom surface 30 of the bottom plate Cb1, a substantially conical support pin 72 that projects from the plate section 71 to the optical sheet 20 side and supports the optical sheet 20, a light source holding section 74 that also projects from the plate section 71 to the optical sheet 20 side and holds the hot-cathode tubes 50, and a locking section 73 that projects from the plate section 71 to the bottom plate Cb1 side and is used to attach the lamp clip 70 to the bottom plate Cb1. On the center side in the shorter-side direction (the Y axis direction) of the second cabinet Cb, a locking section attachment hole 30A is formed to pierce through the bottom plate Cb1. Locking sections 73 are configured to pierce through locking section attachment holes 30A and to be locked to the rear side of the bottom plate Cb1. Specifically, the distal end portion of the locking section 73 is set to, on the proximal end side, a diameter larger than the inner diameter of the locking section attachment hole and is set to a smaller diameter toward the distal end. The distal end portion of the locking section 73 is elastically deformable to be reduced in diameter in the Y axis direction. With this configuration, when the distal end portion of the locking section 73 is inserted through the locking section attachment hole 30A from the front side, the distal end portion is deformed to be reduced in diameter. When the distal end portion of the locking section 73 finishes passing through the locking section attachment hole 30A, the distal end portion elastically returns. Consequently, the locking section 73 is locked to the hole edge of the locking section attachment hole 30A from the rear side.

The light source holding section 74 is arranged in plural places (in this embodiment, two places) along the Y axis direction on the plate section 71. Plural (in this embodiment, two) hot-cathode tubes 50 are attached with respect to one lamp clip. The light source holding section 74 is formed in an ended annular shape with a part of the distal end thereof opened and is elastically deformable in the width direction (the Y axis direction). Consequently, a distal end portion 74B surrounds a part of the circumferential surface of the hot-cathode tube 50. The hot-cathode tube 50 can be attached and detached from the front side of the distal end portion 74B.

The lamp clip 70 is arranged in the second cabinet Cb on the center side in the shorter-side direction (the Y axis direction, the shorter-side direction) thereof. The two hot-cathode tubes 50 held by the light source holding section 74 are also arranged in the second cabinet Cb on the center side in the shorter-side direction (the Y axis direction) thereof. In the following explanation, a region where the hot-cathode tubes 50 are arranged is referred to as a light source arrangement region 30a (a center section).

Since the hot-cathode tubes 50 are arranged in the center in the second cabinet Cb, board housing sections 30b (outer side sections) are respectively formed on both end sides in the Y axis direction in the second cabinet Cb (a region other than the light source arrangement region 30a). More specifically, the board housing section 30b is a region formed to extend in the X axis direction and surrounded by three surfaces (three members) of the bottom plate Cb1, the wall plate Cb2, and the tilting section 60B of the reflection sheet 60 (a region of a substantially triangular shape in sectional view of FIG. 3). The circuit boards 80 are arranged in the board housing section 30b. Specifically, the circuit boards 80 are respectively attached to the bottom plate Cb1 and the wall plate Cb2. Examples of the circuit boards 80 include a power supply board (an inverter board) for supplying driving power to the hot-cathode tube 50 and a video control board for controlling a video in the television receiver TV.

In the Y axis direction, length Y2 of the light source arrangement region 30a and length Y1 of the board housing sections 30b (the board housing section 30b is larger as Y1 is larger) depend on an arraying interval in the Y axis direction of the hot-cathode tubes 50. Specifically, when the arraying interval of the hot-cathode tubes 50 is set small (i.e., in the Y axis direction, the hot-cathode tubes 50 are arranged to be aggregated near the center of the second cabinet Cb), the length Y2 of the light source arrangement region 30a is reduced and the length Y1 of the board housing section 30b can be relatively set large.

As the hot-cathode tubes 50 are arranged to be aggregated nearer the center of the second cabinet Cb, the luminance on the both end sides further falls. Therefore, it is more likely that the luminance is non-uniform on an emission surface of the backlight device 12. In order to suppress the luminance fall on the both end sides, it is desirable to set the length Y1 of the board housing sections 30b small and set the length Y2 of the light source arrangement region 30a larger. In other words, it is desirable to set the length Y1 of the board housing section 30b such that the board housing section 30b is formed in a minimum size for allowing the circuit board 80 to be arranged in the board housing section 30b. Therefore, in this embodiment, the circuit board 80 is attached to the wall plate Cb2 to arrange the circuit board 80 (denoted by sign 80A) in a state tilting with respect to the Y axis direction. As a result, compared with a configuration in which the circuit board 80 is arranged along the Y axis direction, the length Y1 of the board housing section 30b is smaller.

In the diffuser 22 according to this embodiment, a white dot pattern is formed on a surface on a side opposed to the hot-cathode tubes 50 (hereinafter referred to as opposed surface 22A). The dot pattern is formed by printing, for example, paste containing a metal oxide on the surface of the diffuser 22. As means for the printing, screen printing, ink jet printing, and the like are suitable.

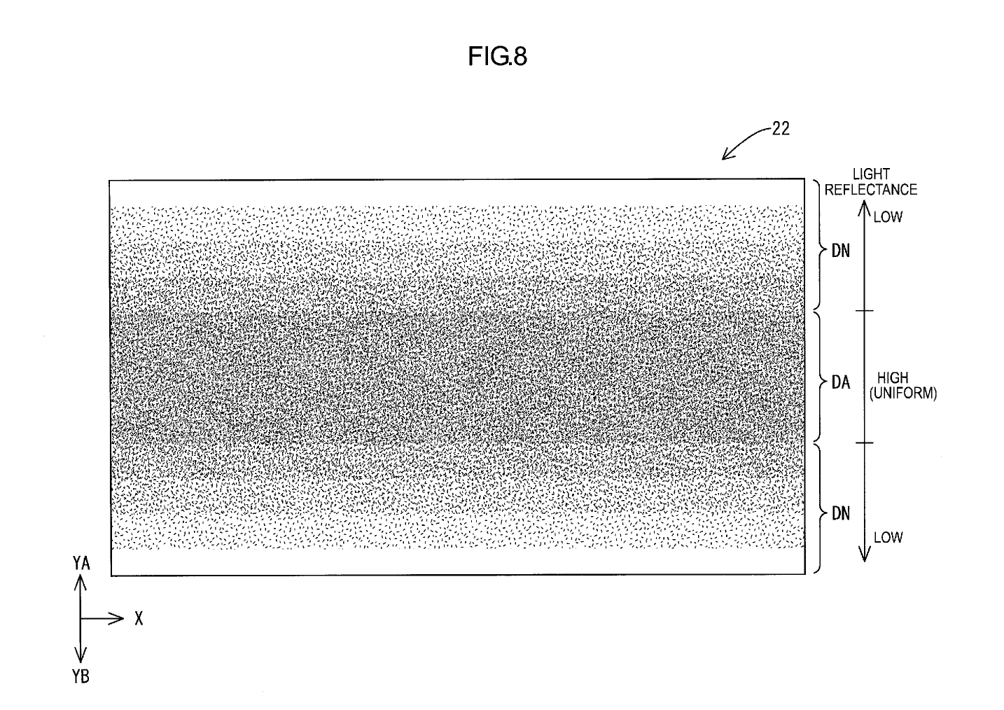

The diffuser 22 is set such that the light reflectance of the opposed surface 22A changes along the Y axis direction by changing an area of dots forming the dot pattern (or distribution density of the dots). Specifically, as shown in FIGS. 3 and 8, in the opposed surface 22A, the light reflectance of a surface opposed to the light source arrangement region 30a (hereinafter referred to as light source superimposed surface DA) is set larger than the light reflectance of a surface opposed to the board housing section 30b (hereinafter referred to as light source non-superimposed surface DN). In the light non-superimposed surface DN of the diffuser 22, the light reflectance is set to continuously gradually decreases from a side close to the light source superimposed surface DA to a side far from the light source superimposed surface DA (in FIG. 8, a YA end and a YB end). It is possible to increase the light reflectance by setting the area or the distribution density of the dots large.

If the light reflectance is distributed as explained above, first, light emitted from the light source arrangement region 30a reaches the light source superimposed surface DA of the diffuser 22, i.e., a region where the light reflectance is relatively large (a beam LA in FIG. 3). Therefore, most of the light is reflected (i.e., is not transmitted to the front side of the diffuser 22). On the other hand, the light reflected on the light source superimposed surface DA is further reflected by the reflection sheet 60 and the like and can reach the light source non-superimposed surface DN of the diffuser 22 (a beam LB in FIG. 3). Since the light reflectance of the light source non-superimposed surface DN is set relatively small, the transmittance of the light is higher than that of the light source superimposed surface DA and a relatively large amount of light is transmitted.

In this way, the light emitted from the light source arrangement region 30a is reflected to the inside of the second cabinet Cb (the rear side) in the region where the light reflectance of the diffuser 22 is relatively large (the light source superimposed surface DA), whereby the light can be led to both end sides in the Y axis direction in the second cabinet Cb. The light reflectance of the light source non-superimposed surface DN corresponding to the board housing section 30b is set relatively small, whereby lighting light from a place where the hot-cathode tubes 50 are not arranged can be secured. As a result, it is possible to set the luminance of the backlight device 12 uniform while arranging the hot-cathode tubes 50 in the center in the Y axis direction in the second cabinet Cb.

Next, a method of assembling the liquid crystal display device 10 according to this embodiment is explained. First, the liquid crystal panel 11 is attached to the first cabinet Ca. In other words, the liquid crystal panel 11, which is separately manufactured, is attached to the claw section 13 of the first cabinet Ca. However, as shown in FIG. 5, the liquid crystal panel 11 is pushed against the slope 13a of the claw section 13 (in an arrow direction) from the rear side of the first cabinet Ca to elastically deform the claw section 13 in the widening direction (the outer side) and house the liquid crystal panel 11 between the locking surface 13b and the elastic member 16. When the liquid crystal panel 11 is housed between the locking surface 13b and the elastic member 16, the claw section 13 elastically returns and the liquid crystal panel 11 is prevented or suppressed from dropping from between the locking surface 13b and the elastic member 16.

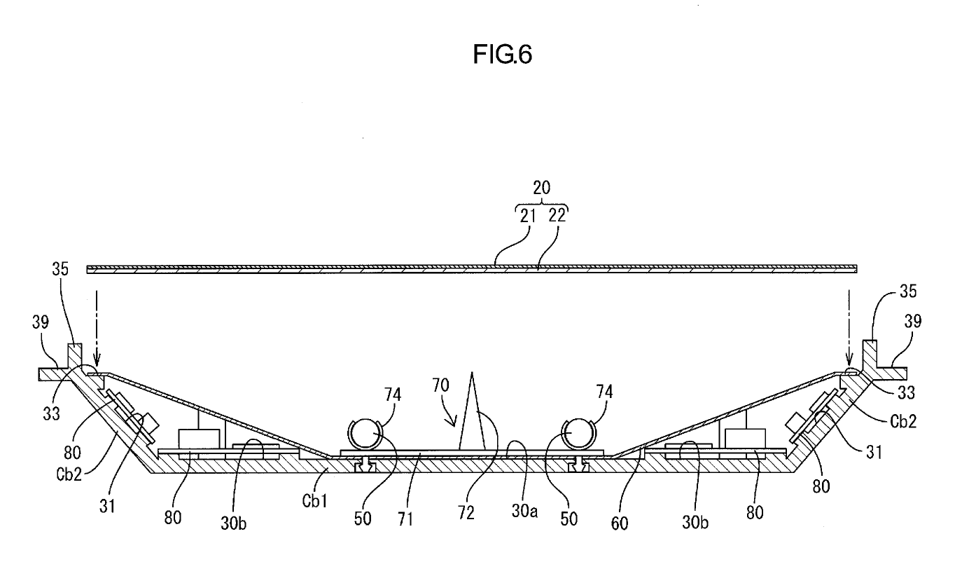

On the other hand, the optical sheet 20 is placed on the second cabinet Cb. Specifically, as shown in FIG. 6, the optical sheet 20 is placed in a region surrounded by projections 35, i.e., on the sheets holding section 33.

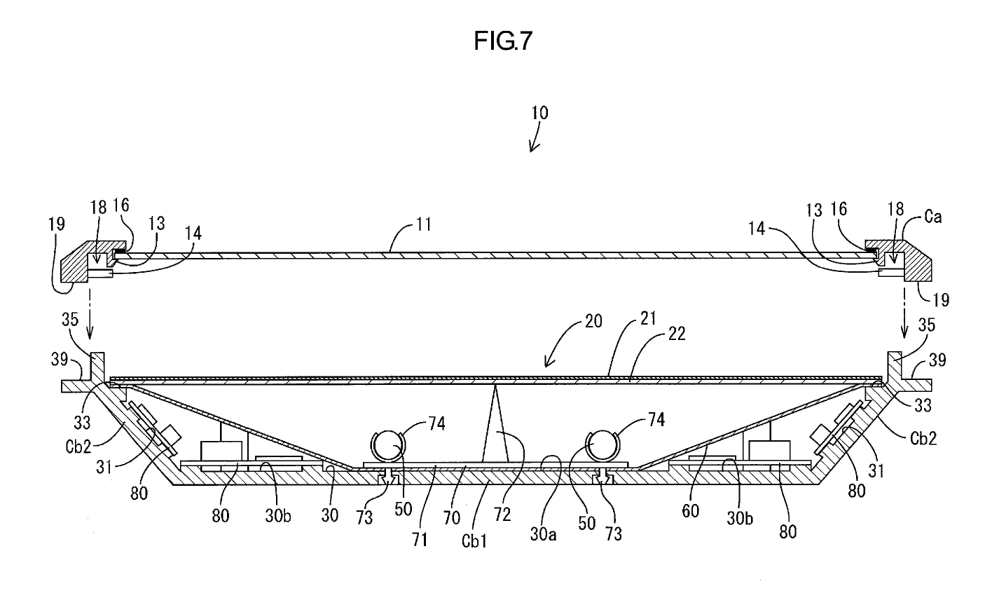

As shown in FIG. 7, the first cabinet Ca and the second cabinet Cb are assembled with the attachment surfaces 19 and 39 thereof opposed to each other and such that the projection 35 is housed in the projection housing section 18 of the first cabinet Ca. According to the assembling, the optical sheet 20 is held between the pieces for holding 14 of the first cabinet Ca and the sheets holding section 33 of the second cabinet Cb. The liquid crystal display device 10 is completed according to such engagement of the first cabinet Ca and the second cabinet Cb. The liquid crystal display device 10 is supported by the stand S (see FIG. 1), whereby the television receiver TV is provided.

As explained above, in the backlight device 12 in this embodiment, the hot-cathode tubes 50 are arranged in the center in the shorter-side direction of the second cabinet Cb to form the board housing sections 30b respectively in both the outer side sections in the shorter-side direction. The circuit boards 80 are respectively arranged in the board housing sections 30b to arrange the hot-cathode tubes 50 and the circuit boards 80 side by side in the shorter-side direction of the second cabinet Cb. As a result, the thickness (the length in the Z axis direction) of the second cabinet Cb can be reduced as much as possible and the backlight device 12 can be reduced in thickness. In order to form the board housing section 30b, for example, a configuration is also conceivable in which the hot-cathode tubes 50 are arranged on one end side in the shorter-side direction (the Y axis direction) in the second cabinet Cb and the other end side is formed as the board housing section 30b. However, in this configuration, since a distance from the hot-cathode tubes 50 to the other end side increases, the luminance on the other end side is low compared with the luminance on one end side and luminance unevenness tends to occur. In this regard, in the present invention, the hot-cathode tubes 50 are arranged in the center in the shorter-side direction in the second cabinet Cb. Therefore, it is possible to suppress luminance unevenness compared with a configuration in which the hot-cathode tubes 50 are arranged on one end side.

The liquid crystal display device 10 includes the optical sheet 20 that diffuses the light from the hot-cathode tubes 50. With such a configuration, since the light from the hot-cathode tubes 50 is diffused, the luminance in the center where the hot-cathode tubes 50 are arranged and the luminance in the outer side section where the hot-cathode tubes 50 are not arranged can be made more uniform. Therefore, it is possible to suppress luminance unevenness.

The hot-cathode tubes 50 are used as the light sources. Since the hot-cathode tubes 50 with which high luminance can be obtained at a relatively low voltage are used, it is possible to reduce the number of light sources necessary for securing the luminance of the backlight device 12 compared with the number of light sources necessary when light sources having luminance lower than that of the hot-cathode tubes 50 are used. By reducing the number of light sources, it is possible to reduce a region were the light sources are arranged and form the board housing section 30b relatively large. It is possible to reduce cost according to the reduction in the number of light sources.

The second cabinet Cb is made of a synthetic resin. With such a configuration, it is possible to realize a reduction in weight and a reduction in cost of the second cabinet Cb.

The liquid crystal display device 10 includes the first cabinet Ca to which the liquid crystal panel 11 is attached. The second cabinet Cb and the first cabinet Ca are engaged with each other to configure the cabinet that is the exterior component of the liquid crystal display device 10. With such a configuration, since an intermediate attachment member such as a bezel or a chassis is disused, it is possible to reduce the thickness of the liquid crystal display device 10 compared with a configuration including the intermediate attachment member. Since the intermediate attachment member is disused, it is possible to reduce material cost. Further, the liquid crystal display device 10 can be completed simply by engaging the second cabinet Cb and the first cabinet Ca. Therefore, it is possible to reduce the number of assembly processes compared with the configuration including the intermediate attachment member. In this regard, it is also possible to reduce cost.

### Second Embodiment

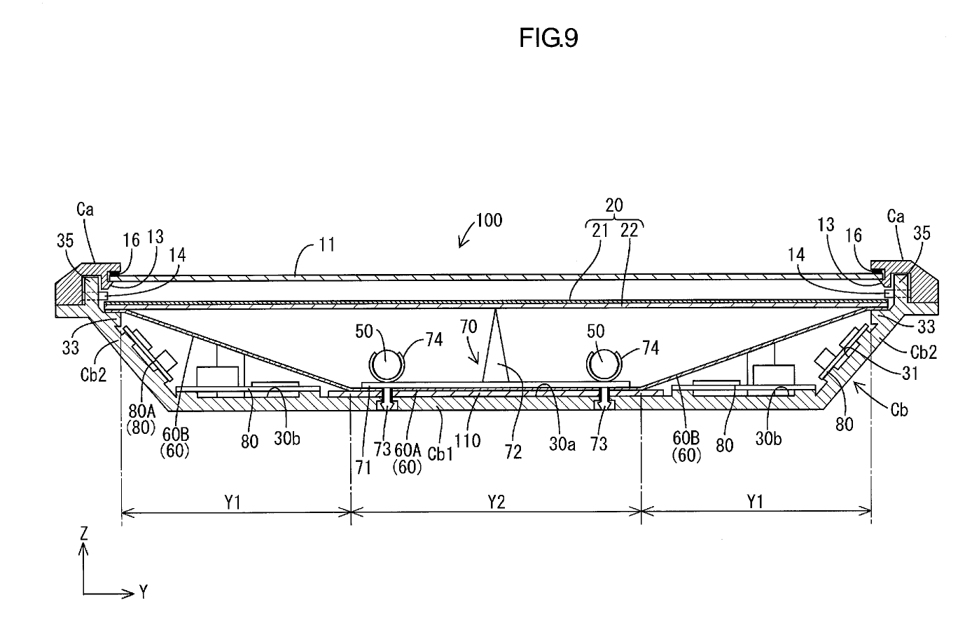

A second embodiment of the present invention is explained with reference to FIG. 9. A liquid crystal display device 100 according to the second embodiment is different from the first embodiment in a configuration including a sheet supporting member 110 for supporting the reflection sheet 60. In the second embodiment, components having names same as those in the first embodiment are denoted by the same reference numerals and signs and redundant explanation is omitted concerning structures, actions, and effects.

The sheet supporting member 110 is made of, for example, a synthetic resin and, in plan view, formed in a flat shape having a size substantially the same as the bottom section 60A of the reflection sheet 60. The sheet supporting member 110 is laid on the bottom plate Cb1 in the second cabinet Cb and supports the bottom section 60A of the reflection sheet 60. Since the second cabinet Cb in this embodiment is a member for attaching various components such as the power supply board, irregularities (e.g., holes for attachment and wall sections for alignment) tend to be formed. Therefore, if the reflection sheet 60 is directly laid on the bottom plate Cb1 of the second cabinet Cb as in the first embodiment, in some case, a bend and a lift occur in the reflection sheet 60 because of the irregularities of the bottom plate Cb1. Therefore, in this embodiment, the flat sheet supporting member 110 is interposed between the second cabinet Cb and the reflection sheet 60 as explained above. With such a configuration, compared with a configuration in which the reflection sheet 60 is directly laid on the bottom plate Cb1, it is possible to suppress occurrence of a bend and a lift in the reflection sheet 60 and suppress luminance unevenness due to the bend and the lift. The material of the sheet supporting member 110 is not limited to a synthetic resin and may be, for example, a metal.

### Third Embodiment

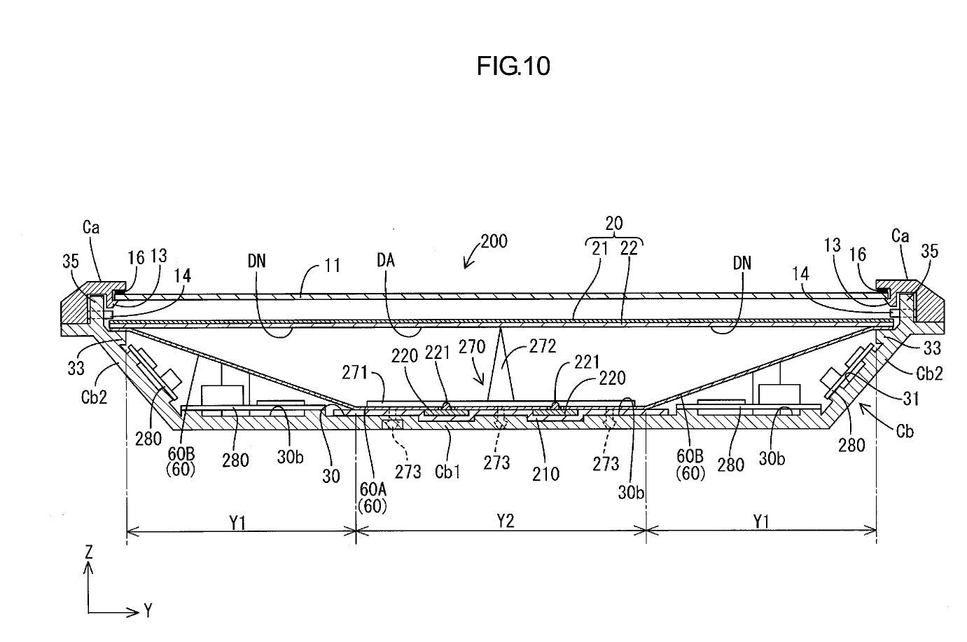

A third embodiment of the present invention is explained with reference to FIGS. 10 to 12. A liquid crystal display device 200 according to the third embodiment is different from the embodiments explained above in a configuration in which LEDs 221, which are point light sources, are used as the light sources. The lamp clip 70 according to the embodiments is disused and a retaining member 270 is provided. In the third embodiment, components having names same as those in the first embodiment are denoted by the same reference numerals and signs and redundant explanation is omitted concerning structures, actions, and effects.

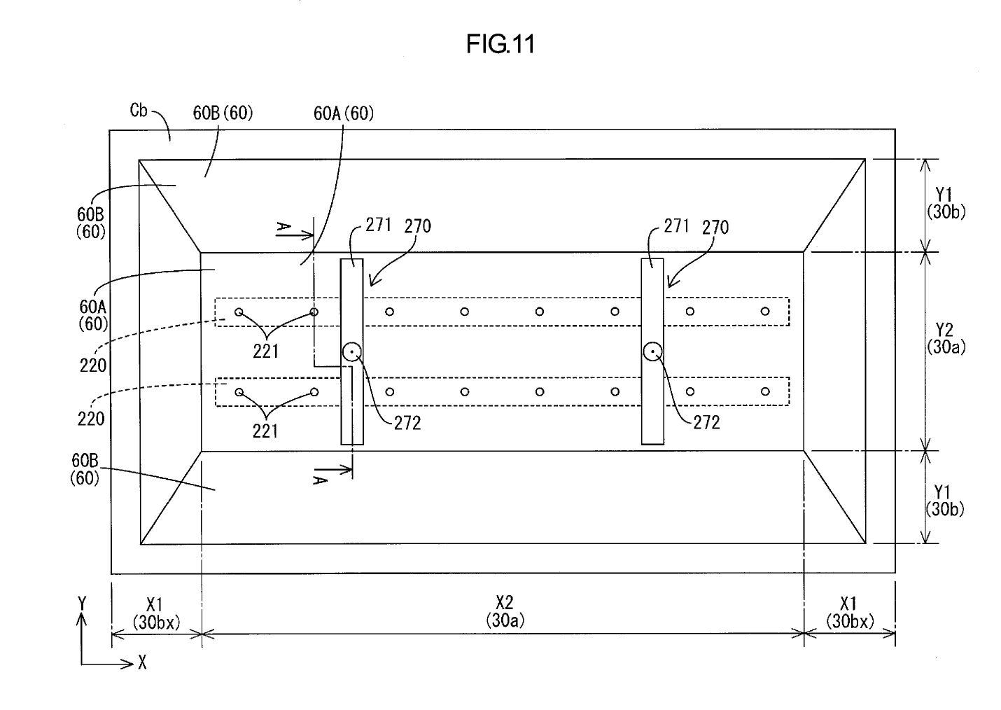

In this embodiment, on the bottom surface 30 of the second cabinet Cb, an LED board 220 mounted with plural LEDs 221 is arranged via a sheet supporting member 210. As shown in FIG. 11, the LED board 220 is formed in a rectangular shape long in the X axis direction. The plural LEDs 221 are mounted at an equal interval along the X axis direction. In the LED 221, for example, an LED chip that emits light of a single color blue and a fluorescent material are combined to emit white light. The LEDs 221 are electrically connected to a circuit board 280 (a power supply board) and configured to receive the supply of driving power.

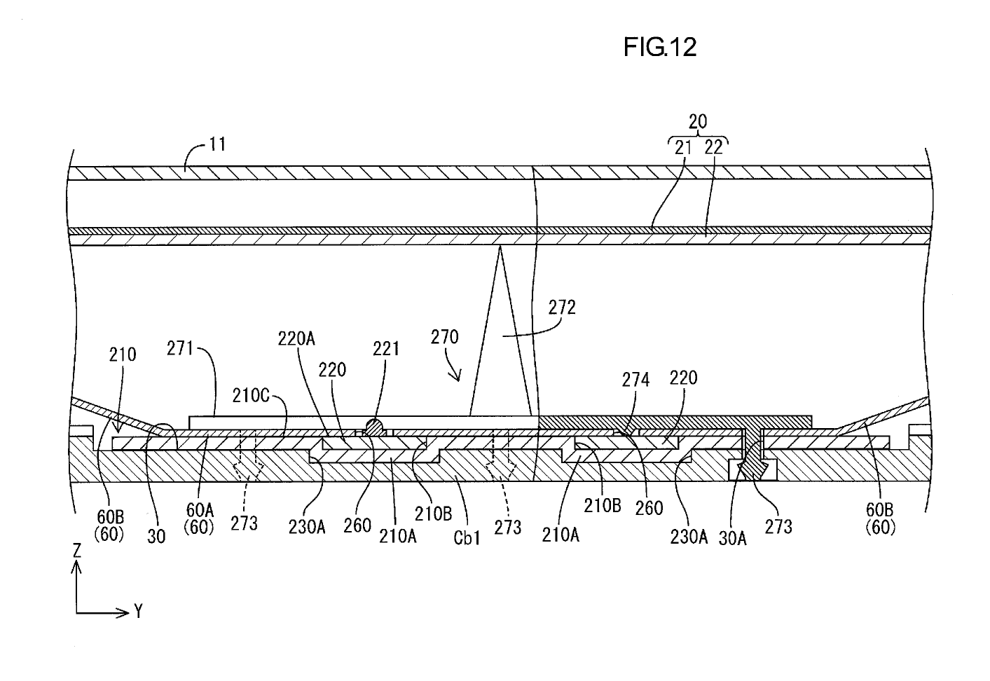

As shown in FIG. 12, in the bottom plate Cb1 of the second cabinet Cb, the bottom surface 30 of the bottom plate Cb1 is dent to form groove sections 230A. The groove sections 230A are formed in two places in the center in the shorter-side direction of the second cabinet Cb. The groove sections 230A extend in length corresponding to the LED board 220 along the X axis direction and are arranged side by side in parallel to each other.

The sheet supporting member 210 is made of, for example, a synthetic resin and, in plan view, formed in a flat shape having a size same as the bottom section 60A of the reflection sheet 60. As shown in FIG. 12, in the sheet supporting member 210, places corresponding to the groove sections 230A are projected to the rear side (the lower side in FIG. 12) to respectively form alignment projections 210A that can be fit in the groove sections 230A and board attachment grooves 210B in which the LED board 220 can be fit. The alignment projections 210A are fit in the groove sections 230A to align the sheet supporting member 210 in the X axis direction. LED boards 220 are respectively fit in the board attachment grooves 210B, whereby two LED boards 220 are arranged in the center in the shorter-side direction of the second cabinet Cb while being aligned in the X axis direction. As shown in FIG. 12, a surface 210C of the sheet supporting member 210 and a surface 220A of the LED board 220 are flush with each other. Consequently, when the bottom section 60A of the reflection sheet 60 is laid over both the surfaces 210C and 210A, a bend and a lift are suppressed from occurring.

As shown in FIGS. 11 and 12, the retaining member 270 is a member for retaining the LED board 220 between the retaining member 270 and the second cabinet Cb. The retaining member 270 includes a plate section 271 extending over both the LED boards 220 in the Y axis direction, a support pin 272 that projects from the plate section 271 to the optical sheet 20 side and supports the optical sheet 20, and plural (in this embodiment, three) locking sections 273 that project from the plate section 271 to the bottom plate Cb1 side and are used to attach the retaining member 270 to the bottom plate Cb1. Since the locking section 273 has a configuration same as that of the locking section 73 in the lamp clip 70 in the first embodiment, explanation of the locking section 273 is omitted.

In the plate section 271, a projection 274 is formed to the rear side in a place corresponding to the LED board 220. The LED board 220 is pressed by the projection 274 to retain the LED board 220. Through-holes 260 are respectively formed in places corresponding to the LED 221 and the projection 274 in the bottom section 60A of the reflection sheet 60. The LED 221 and the projection 274 can be inserted through the through-holes 260.

As explained above, in this embodiment, like the hot-cathode tubes 50 in the first embodiment, the LEDs 221 (the LED board 220) are arranged in the center in the shorter-side direction of the second cabinet Cb to form the board housing sections 30b on both the end sides of the second cabinet Cb. Consequently, in the second cabinet Cb, it is possible to arrange the LEDs 221 (the LED board 220) and the circuit board 280 side by side in the Y axis direction and reduce the thickness of the second cabinet Cb.

In the X axis direction, the length of the LED board 220 is set smaller than the length of the second cabinet Cb. In the X axis direction, the LED board 220 is also arranged in the center of the second cabinet Cb. Consequently, on both the end sides in the X axis direction, it is also possible to form regions where the LEDs 221 (and the LED board 220) are not arranged and use the region as board housing sections 30bx.

Action and effects obtained by using the LEDs 221, which are the point light sources, as the light sources are explained. The LEDs 221 are arrayed in one direction (in this embodiment, the X axis direction) on the LED board 220. Plural (in this embodiment, two) LED boards 220 are arrayed in the Y axis direction to two-dimensionally array the LEDs 21 and form a surface light source. In other words, it is possible to change the length in the X axis direction of the LED boards 220 by changing the number of arrays of the LEDs 221 mounted on the LED boards 220 or an interval between the LEDs 221. On the other hand, when the hot-cathode tubes 50 in the first embodiment or the like are used as the light sources, the length in the X axis direction of the hot-cathode tubes 50 is predetermined length to a certain degree. It is difficult to change the length.

Therefore, in this embodiment, it is possible to change length X2 in the X axis direction of the light source arrangement region 30a by changing the length in the X axis direction of the LED boards 220. It is possible to change length Y2 in the Y axis direction of the light source arrangement region 30a by changing an arraying interval in the Y axis direction of the LED boards 220. With such a configuration, it is possible to flexibly adjust the length Y1 of the board housing section 30b and the length X1 of the board housing section 30bx. It is possible to further improve a degree of freedom of design compared with a degree of freedom of design obtained when linear light sources like hot-cathode tubes having predetermined length are used as the light sources. Since the LEDs 221 are used as the light sources, it is also possible to suppress power consumption.

### Other Embodiments

The present invention is not limited to the embodiments explained according to the above description and the drawings. For example, embodiments explained below are also included in the technical scope of the present invention.

(1) In the embodiments explained above, the configuration in which the light sources are arranged in the center in the shorter-side direction of the second cabinet Cb is adopted. However, the present invention is not limited to this. A configuration in which the light sources are arranged in the center in the longer-side direction of the second cabinet Cb to form the board housing sections on both sides in the longer-side direction may be adopted.

(2) In the embodiments explained above, both the outer side sections in the shorter-side direction of the second cabinet Cb are formed as the board housing sections 30b. However, the board housing section 30b may be formed only on one side of the outer side sections.

(3) In the embodiments explained above, the space surrounded by the tilting section 60B of the reflection sheet and the bottom plate Cb1 and the wall plate Cb2 of the second cabinet Cb is formed as the board housing section 30b. However, the present invention is not limited to this configuration. In the second cabinet Cb, a space other than the light source arrangement region 30a can be arbitrarily used as the board housing section.

(4) In the aforementioned embodiments, the configuration in which the hot-cathode tubes 50 or the LED boards 220 are arrayed in two rows in the Y axis direction. However, the present invention is not limited to this. The number of arrays of the hot-cathode tubes 50 or the LED boards 220 can be changed as appropriate.

(5) In the embodiments explained above, the optical sheet 20 such as the diffuser 22 is cited as the example of the optical member that diffuses light from the light sources. However, the present invention is not limited to this. The optical member may be, for example, a diffusing lens that can diffuse light from the light sources. For example, in the third embodiment, a configuration in which the LEDs 221 are covered with diffusing lenses to diffuse light can be adopted. Both the diffuser 22 and the diffusing lens can be used together as the optical member.

(6) In the aforementioned embodiments, the first cabinet Ca and the second cabinet Cb are made of a synthetic resin. However, the present invention is not limited to this. The first cabinet Ca and the second cabinet Cb may be made of metal. If the first cabinet Ca and the second cabinet Cb are made of metal, strength can be increased. By surrounding the circuit board 80 such as the power supply board with metal, it is possible to suppress electromagnetic noise from the circuit board 80 from being radiated to the outside of the backlight device 12, block electromagnetic noise from the outside, and further improve operation reliability of the circuit board 80.

(7) In the aforementioned embodiments, the power supply board and the video control board are cited as the examples of the circuit board 80. However, the circuit board 80 may be a circuit board other than the power supply board and the video control board and may be, for example, a circuit board such as a tuner.

(8) In the aforementioned embodiments, the configuration in which the housing member is the second cabinet Cb and the panel attachment member is the first cabinet Ca is cited as the example. However, the present invention is not limited to this. For example, a configuration in which the housing member is a chassis and the light sources, the circuit board 80, and the like are housed in the chassis may be adopted. A display panel may be held by the chassis and a bezel to configure the panel attachment member.

(9) In the aforementioned second embodiment, the sheet supporting member 110 is made of a synthetic resin. However, the present invention is not limited to this. For example, the sheet supporting member 110 may be made of a metal.

(10) In the aforementioned embodiments, the hot-cathode tubes 50 are used as the light sources. However, a liquid crystal display device including other types of light sources such as cold-cathode tubes is also included in the present invention.

(11) In the aforementioned embodiments, the configuration in which the LEDs 221 are used as the point light sources is cited as the example. However, a configuration in which point light sources other than the LEDs are used may be adopted.

(12) In the aforementioned embodiments, the LED 221 including the LED chip that emits blue light and the fluorescent material is cited as the example. However, the present invention is not limited to this. For example, the LED 221 may have a configuration including an LED chip that emits ultraviolet ray and a fluorescent material. The LED 221 may have a configuration including three types of LED chips that emit lights of single colors of R (red), G (green), and B (blue). The LED 52 may have a configuration in which the three kinds of LED chips that emit lights of single colors of R (red), G (green), and B (blue) are combined.

(13) In the aforementioned embodiments, the TFT is used as the switching element of the liquid crystal display device 10. However, the present invention can also be applied to a liquid crystal display device including a switching element other than the TFT (e.g., a thin film diode (TFD)). Besides the liquid crystal display device that performs color display, the present invention can also be applied to a liquid crystal display device that performs monochrome display.

(14) In the aforementioned embodiments, the liquid crystal display device including the liquid crystal panel 11 as the display element is cited as the example. However, the present invention can also be applied to display devices including display elements of other types.

(15) In the aforementioned embodiments, the television receiver TV including the tuner is cited as the example. However, the present invention can also be applied to a display device not including a tuner.

1. A lighting device comprising:
a light source;
a power supply board configured to supply electric power to the light source; and
a housing member having a rectangular shape in plan view and housing the light source and the power supply board,
wherein the light source is arranged in a center area of the housing member with respect to a longer-side direction or a shorter-side direction of the housing member to form a board housing section in at least one of outer areas each located on either side of the center area with respect to the longer-side direction or the shorter-side direction of the housing member, the board housing section housing the power supply board.

2. The lighting device according to claim 1, further comprising an optical member configured to diffuse the light from the light source.

3. The lighting device according to claim 1 or 2, further comprising:
a reflection sheet arranged on an inner surface of the housing member; and
a flat sheet supporting member arranged between the housing member and the reflection sheet, and supporting the reflection sheet.

4. The lighting device according to claim 1, wherein the light source is a hot-cathode tube.

5. The lighting device according to claim 1, wherein the light source is a point light source.

6. The lighting device according to claim 5, wherein the point light source is a light emitting diode.

7. The lighting device according to claim 1, wherein the housing member is made of a synthetic resin.

8. The lighting device according to claim 1, wherein the housing member is made of a metal.

9. A display device comprising:
the lighting device according to claim 1; and
a display panel configured to provide display using light from the lighting device.

10. The display device according to claim 9, further comprising a panel attachment member to which the display panel is attached,
wherein the housing member and the panel attachment member are engaged with each other to configure a cabinet that is an exterior component of the display device.

11. The display device according to claim 9, wherein the display panel is a liquid crystal panel including liquid crystals.

12. A television receiver comprising the display device according to claim 9.
